(19) United States
(12) Patent Application Publication
(10) Pub. No.: US 2007/0222454 A1
(43) Pub. Date: Sep. 27, 2007

(54) Method and Device for the Operation of an Exhaust Gas Analyzing Sensor Cell

(76) Inventor: Torsten Reitmeier, Wackersdorf (DE)

Correspondence Address: COHEN, PONTANI, LIEBERMAN & PAVANE, 551 FIFTH AVENUE, SUITE 1210, NEW YORK, NY, 10176, US

(21) Appl. No.: 11/587,291

(22) PCT Filed: Mar. 15, 2005
(86) PCT No.: PCT/EP05/51178

§ 371 Date: Oct. 19, 2006

(30) Foreign Application Priority Data
Apr. 19, 2004 (DE) 2004 018 871.8

(51) Int. Cl. G01N 27/417

(52) U.S. Cl. 324/425

(57) ABSTRACT

The invention relates to a method and a device for operating a sensor cell (1) that is used for analyzing exhaust gas. The aim of the invention is to create a method and a corresponding device which supply reliable test results in each mode of operation of a sensor, also when using advantageous pulse width-controlled regulation of the heating element (6). Said aim is achieved by correcting the potential of the reference electrode (Ref) of the sensor substantially in synchrony with the mean of the supply voltage (Vpwm) of the electrical heating element (6).

### DESCRIPTION

Method and device for the operation of an exhaust gas analyzing sensor cell.

The present invention relates to a method and a device for operating a sensor cell for exhaust gas analysis, as is used in a known manner in the exhaust gas ducts of internal combustion engines for regulating and reducing pollutant emissions. In this case, exhaust gas analyzing sensor cells of this kind are used to determine the content of nitrogen oxides and other gases harmful to the environment that are part of an exhaust gas mixture. For control purposes, the required control variables are prepared from the electrical output signals of these sensors.

Electrically heated ceramic probes have proved suitable as τ-probes and nitrogen oxide or NOx sensors for motor vehicle exhaust gases. Zirconium oxide ZrO₂, which is heated in operation to temperatures between 300 to 850° C. by an electrical resistance heater, is mainly used as the ceramic material.

Without limiting the invention to this particular application, only ceramic wideband probes such as are used as τ and nitrogen oxide sensors in automotive engineering for the control of pollutant emissions are dealt with in the following text. With the construction of τ and nitrogen oxide sensors being essentially the same, these probes and sensors are arranged in the exhaust gas duct in such a way that τ sensors are positioned in the exhaust gas duct before a catalyzer and nitrogen oxide sensors after a catalyzer. A wideband probe, in contrast to the finger, planar or resistance step probes not considered further here, not only measures in a range of τ≈1 but also continuously over a wide τ range of the mixtures from rich to lean. To do this, wideband probes have two cells, i.e. a pump cell and a concentration cell, also known as a sensor cell or a Nernst cell. Therefore a corresponding closed-loop control system using the output signal of a wideband probe is able to continuously provide every required air ratio τ in the combustion chamber of an internal combustion engine.

A wideband τ probe, consisting in principle of two cells, is in contact with three different media, i.e. air from the environment, an exhaust gas mixture and a τ-one mixture. The τ-one mixture is automatically generated in the measuring chamber from exhaust gas and ambient air by a pump flow Iₚ. This pump flow Iₚ is evaluated as a measure of the air ratio τ. However, in order to be able to activate this process at all, the wideband probe must previously be brought to a minimum operating temperature of about 500° C. At this temperature the zirconium-oxide ceramic loses its property as an electrical insulator to a point where it becomes permeable to oxygen ions and acts as a solid electrolyte for the ion transport.

Because of the low space requirement and a more economic production, modern exhaust gas sensors are usually provided with a heater layer for electrical heating of the wideband sensor to its operating temperature, which is arranged directly on the ceramic and can be produced without additional electrical insulation, such as for example can be provided by an air gap. This applies to types of planar or resistance step probes and also to ceramic wideband sensors. For such wideband sensors based on zirconium-oxide ceramic, the German Laid-open Specification DE 102 21 392 A1 disclose a particularly advantageous method for the control of the heating element where used as an NOx sensor, which is based on the use of a periodically switchable, pulse width-modulated current with an adjustable pulse width. When its operating temperature has been reached, the effectiveness of the electrical insulation of the electrical heating element with respect to the measuring electrodes of the sensor is however very limited. Because this means that a current flow can no longer be effectively cut off when a minimum operating temperature is reached, the measuring result of the sensor can be significantly falsified by the described effect. Even the use of an intermediate layer of aluminum-oxide ceramic does not bring about an effective improvement at the operating temperature of a sensor, because the resistance of the Al₂O₃ material and thus also the electrical insulating effect of this material reduces very strongly with increasing temperature.

The object of the present invention is therefore to provide a method and a corresponding device that delivers reliable measuring results in every operating state of a sensor even with the use of the advantageous pulse width-controlled regulation of the heating element. This object is achieved according to the invention by a method and a device with the features of the respective independent claims, in that a respective electrical reference of a respective sensor is modified essentially in synchrony with the arithmetical mean of the supply voltage of the electrical heating element, i.e. an electrode P+ as a reference with a wideband sensor with PWM-regulated heater voltage. Accordingly, in a device according to the invention, means are provided to determine, in conjunction with a circuit to correct the potential of a reference electrode of the sensor, an arithmetical mean or direct component of the input voltage of the electrical heating element that has been pulse width-modulated and closed loop regulated or modified in some other manner.

This invention is based on the knowledge that with exhaust gas sensors with a heater layer applied directly to the respective ceramic without an air gap, creepage currents between the heater layer and a reference electrode cannot be prevented, with the result that measuring errors necessarily result, at least in a closed-loop regulated heating operation, because of the displacement of the reference potential. Moreover, it has been shown that a significant measuring error in the pulse width-modulated, closed-loop regulation of the heater layer occurs, as is for example proposed in DE 102 21 392.5 as the operating mode for light loading of the electrodes. An alleviation of the problem by precluding the influence of electric currents between the heater layer and the reference electrode can be achieved by taking measurements only outside an activity interval of the pulse width-modulated heater voltage signal. However, this approach ignores the fact that the reference potential during these processes does not maintain a constant value, but instead decay occurs at time constants that are large compared with the length of a respective activity interval. Because the potential of the heater layer is generally greater than the potential at the reference electrode of the sensor, an O₂ concentration will, in the case of a multichamber wideband sensor, be adjusted by creepage currents to the mean heating potential.

A further factor influencing the error but not yet fully taken into account in the literature is that the battery or supply voltage in a motor vehicle is load-dependent. Therefore, voltage fluctuations can, for example, arise because the drive for an exhaust gas valve uses the same cable harness as the sensor or its heater layer. The same applies to headlamps or flashers, so that under certain operating conditions a sinusoidal modulation caused by the other vehicle electrical and electronic equipment may have been imposed on the battery voltage as an additional interference variable acting on the exhaust gas sensor.

This is where a device according to the invention for operating a sensor cell comes in, in that it prevents the potentials to be measured being influenced by changes in the battery voltage. For this purpose, in a development of the invention, an electrode P+ as an electrical reference of a wideband sensor with a correction value previously empirically determined or calculated, is to be modified in synchrony with the arithmetical mean of the battery voltage. A weighted direct component of the variable battery voltage is thus added to the potential of the electrical reference electrode.

For this purpose, in a preferred form of embodiment, the control signal of the heater layer as a pulse width-modulated voltage signal is passed through an RC element to determine an arithmetical mean. The output signal of the RC element is amplified by a factor k in an amplifier and added via a summation point to the potential of the electrode P+. A corrected potential difference from which removed the aforementioned interference has been largely removed is thus obtained between the reference electrode and the electrode P+.

Within the scope of this description, this invention is presented essentially against the background of use with wideband sensors in the automotive industry. Planar or resistance step probes as further applications as mentioned in the introduction should, however, not be ignored. In a manner obvious to the person skilled in the art, a unilateral displacement of a reference potential, for example during a resistance measurement, also influences a measuring result in a substained manner. With the, in principle, already relatively narrow measuring range of resistance step probes, the sources that influence the error, previously given by way of example but not fully detailed, substantially reduce the reliability of a closed-loop control signal obtained on this basis.

Further advantages of a method according to the invention and a device for implementing a method according to the invention are described in more detail below by means of the drawing and with reference to the representation of an example of an embodiment. The following are shown in schematic representations.

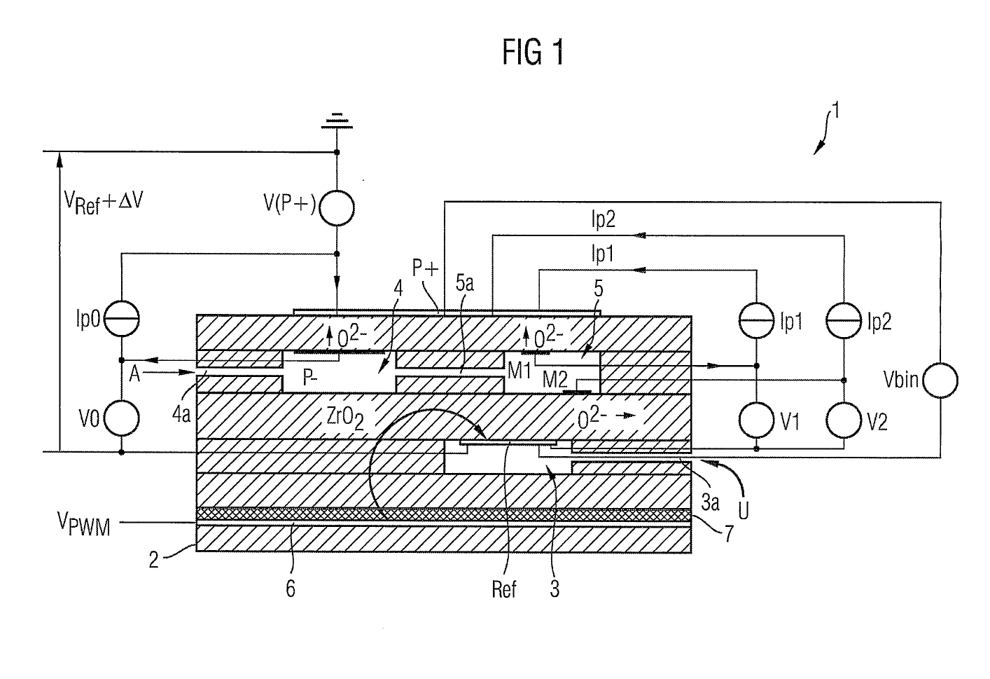

FIG. 1: a sectional view through a wideband sensor for τ measurement with an associated circuit, and

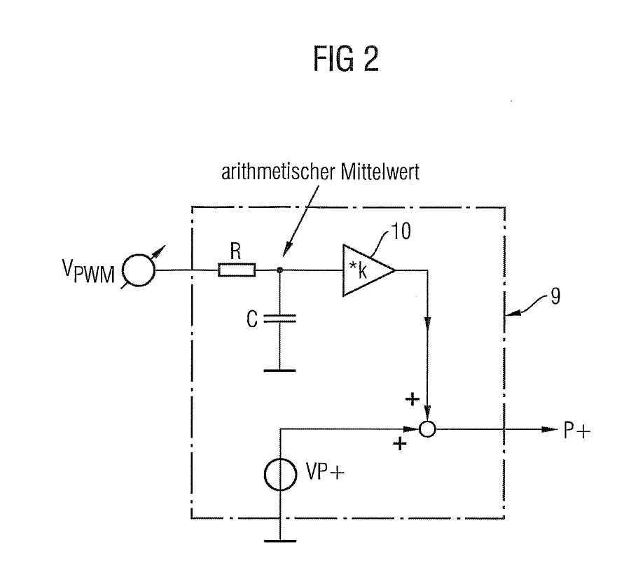

FIG. 2: a block diagram showing an input circuit according to the invention.

In the individual representations of the drawing, the same parts, components and quantities are given the same designations throughout.

FIG. 1 shows a section through a general construction of a measuring sensor that, depending on its specific design, can detect the NOx concentration of combustion products in an exhaust gas duct of an internal combustion engine, or a corresponding air/fuel ratio τ. The illustrated measuring sensor is embodied as sensor 1 and consists essentially of a solid electrolyte 2, in this case zirconium dioxide ZrO₂. As shown in FIG. 1 by the continuously equal hatching, an internal structure with separate chambers, or measuring cells 3, 4, 5 respectively, is created by a layered construction, with the cells being accessible via associated channels 3a, 4a, 5a respectively. The complete ceramic sensor 1 is brought to operating temperature by an electrical heater layer 6, with the control signal of the heater layer 6 being a pulse width-modulated and timed voltage V_{PWM}.

At operating temperatures of about 700° C., an additionally inserted insulation layer 7 of Al₂O₃ ceramic can also not hinder the flow of creepage currents from the higher potential of the heater layer down to the lower potentials within the sensor 1. Measuring points for the potential are arranged in the area of each cell 3, 4, 5 as electrodes Ref, P−, P+, M1 and M2. The measuring accuracy of sensor cell 1 is substantially disturbed in the course of its actual measuring activity by the creepage currents, shown by the curved arrow, and the associated shifts in the potential, as described below.

From the exhaust gas duct, not shown in more detail, the combustion gas mixture A is supplied via channel 4a to the first measuring cell 4. When the sensor 1 is switched on, a small amount of gas passes through channel 5a into the remaining closed cell 5. Here, O₂ ions are pumped via electrodes M1, M2 through the surrounding solid electrolyte, with the external circuitry shown being provided with current and voltage sources. Cell 5 is accordingly designated as a pump cell. Cell 3 is supplied via channel 3a with ambient air U, or fresh external air with an oxygen content of 21%, and serves as a reference cell with respect to sensor cell 4 filled with exhaust gas mixture A.

It can be clearly seen from the schematic illustration in FIG. 1 that the electrode Ref in cell 3 represents the reference potential for all the voltage measurements. Therefore, falsifications τV due to creepage currents and corresponding displacements of this reference potential V_{Ref} have the effect of being the basic error in all voltage and current measurements on the basis of which an NOx content or τ-value is ultimately determined.

FIG. 2 now shows a compensation process, implemented as an input circuit 9, for eliminating the aforementioned errors. The pulse width-modulated and timed control signal V_{PWM} of the heating element 6 is applied to input circuit 9 as an input signal. From this control signal V_{PWM}, an RC element determines an arithmetical mean that, as a direct component of the control signal, is provided with a weighting factor k by an amplifier 10 and added to the potential of electrode P+ to compensate for the displacement of the potential at the reference electrode Ref. In this way, the difference in potential between reference electrode Ref and electrode P+ has been corrected by the direct component which falsifies the measurement.

The correction value k can be either determined empirically in advance in tests or be calculated. For an empirical determination, a relatively simple test can be carried out in a laboratory measuring station in that supply voltages U_{bat} or pulse width-modulated heater control voltages V_{PWM}, for example loaded in defined steps, are applied to a sensor, with the values for NOx or the air/fuel ratio τ remaining the same. Time constants τ in a range of between 3 to 4 seconds are determined from changes in the signal. A calibration measure is obtained therefrom that can be effectively used to counteract fast and periodic disturbances in a range of τt of approximately 1 second.

With a method according to the invention and a corresponding implementation, an overall smooth NOx signal is thus achieved even where there are large battery voltage fluctuations in the dynamic range. This results in a greater accuracy especially for a binary τ signal in the steady-state range, with the variables important for the service life of a previously described sensor 1 being more precisely maintained.

1.-5. (canceled)

6. A method for operating a ceramic exhaust gas analyzing sensor cell electrically heated by a heating element, the method comprising the steps of:
applying a supply voltage to the heating element, the supply voltage comprising a timed, pulse width modulated, or variably controlled signal; and
modifying an electrical reference potential of the sensor cell essentially in synchronicity with an arithmetic mean of the supply voltage, said step of modifying comprising the step of correcting a potential of an electrode in the sensor cell by superimposing a correction value based on the arithmetic mean of the supply voltage.

7. The method of claim 6, wherein the sensor cell is a wideband sensor and the supply voltage is a pulse width modulated regulated voltage.

8. A device for operating a ceramic exhaust gas analyzing sensor cell having a heating element for heating the sensor cell, said device comprising:
means for determining an arithmetic mean or a direct component of a supply voltage to the heating element, the supply voltage comprising a timed, pulse width modulated, or variably controlled signal; and
means for modifying an electrical reference potential of the sensor cell essentially in synchronicity with the arithmetic mean or the direct component of the supply voltage, said means for modifying comprising means for correcting a potential of an electrode in the sensor cell by superimposing a correction value based on the arithmetic mean or the direct component of the supply voltage.

9. The device of claim 8, further comprising an amplifier having an output signal added to the potential of the electrode in the sensor cell.

10. The device of claim 8, further comprising a resistive-capacitive element configured for determining the arithmetic means or the direct component of the supply voltage.
